(19) United States
(12) Patent Application Publication
(10) Pub. No.: US 2006/0099903 A1
(43) Pub. Date: May 11, 2006

(54) Damper system for automotive ventilation

(75) Inventors: Geoffrey H. Bowler, Ballantrae (CA); Karel Caslavsky, Toronto (CA); Iuliu V. Dinescu, Aurora (CA); Thomas Woegerer, Palgrave (CA)

Correspondence Address: LANG MICHENER, BCE PLACE, P.O. BOX 747, SUITE 2500, 181 BAY STREET, TORONTO, ON, M5J 2T7, CA

(73) Assignee: Progressive Moulded Products Limited

(21) Appl. No.: 11/211,551

(22) Filed: Aug. 26, 2005

(30) Foreign Application Priority Data
Oct. 25, 2004 (CA) 2,485,786

(51) Int. Cl. B60S 1/54

(52) U.S. Cl. 454/121

(57) ABSTRACT

A novel damper system for controlling airflow through a plenum provides an effective seal between a rotatable damper door and the plenum to substantially inhibit airflow through the plenum without requiring additional sealing materials such as rubber or foam. When the damper door is in the closed position, an upstanding rib on each of the upper and lower portions of the damper door engage a complementary groove in a respective sealing member on the interior of the plenum against which the damper door faces abut. The engagement of the ribs in the groove provides a seal comprising three surface-to-surface interfaces. The sealing members are relatively small, compared to the size of the plenum, and thus pesent little impediment to airflow through the plenum when the damper door is rotated to an open position.

### FIELD OF THE INVENTION

The present invention relates to a damper system for vents. More specifically, the present invention relates to a damper system for controlling the amount of airflow through the plenum of an air vent in an automotive ventilation system.

### BACKGROUND OF THE INVENTION

Modem automobiles have ventilation systems through which air, either recycled or fresh, can be supplied to various locations within the vehicle. The air can be at ambient temperature or can be heated or cooled, as desired, and can be directed to locations such as floor level vents, defroster vents or fascia level vents.

Air vents for use with such systems are well known and, depending upon their intended location, can include moveable louvers and/or vanes to direct the supplied airflow in a desired direction and can include dampers to control the amount of airflow through the plenum of the vent. Such dampers are often employed with fascia level vents so that passengers in the automobile can control the airflow reaching them independent of the airflow reaching the other passengers, but can also be employed with other vents where it is desired to allow the passengers to control the airflow through the vents.

Generally, such dampers comprise doors, flaps or panels which can be rotated about an axis to interject the damper across the air plenum of the vent. When the damper is rotated to a closed position across the vent plenum, the plenum is blocked and airflow through the vent is, ideally, stopped. Conversely, when the damper is rotated to a fully open position wherein the damper is substantially parallel to the airflow through the vent plenum, the damper does not substantially interfere with airflow through the plenum and a maximum airflow can be achieved. When the damper is rotated to positions intermediate the closed and fully open positions, the airflow is modulated to desired levels between no flow and maximum flow.

An effective seal is required between the damper and the air plenum, when the damper is in the closed position, to prevent “leaks” of air flow past the damper, which leaks would otherwise result in undesired noises such as whistles or other sounds being heard in the passenger compartment and/or some undesired airflow continuing to be provided to the passenger compartment through the vent.

Previous attempts to provide the necessary seal have primarily comprised foam or rubber gaskets being applied to the edges of the damper to abut the plenum walls, thus creating a seal, when the damper is in the closed position. Dampers employing foam seals typically require a moulded damper door, one or more pieces of die cut foam and the assembly of the foam to the moulded damper door. Assembly of the foam to the damper door is relatively expensive in labour costs and also presents a risk of miss-assembly, which would result in air leakage. Further, foam typically degrades over time, leading to eventual failure of the seal and air leakage.

Dampers employing a rubber gasket require a moulded plastic damper door with a soft rubber seal shot on top of the original moulded damper door using a two-shot moulding practice. While rubber gasket damper doors do not require expensive labour for manual assembly, they do require relatively expensive two-shot moulding technology. Further, while less susceptible to degradation over time than foam, rubber can still degrade, reducing the effectiveness of a seal and allowing air leaks to occur.

Other attempts to provide a seal for dampers have included systems wherein a relatively large surface is provided within the plenum for the damper to overlap and abut against to prevent airflow when the damper is closed. An example of such a system is shown in U.S. Pat. No. 6,582,293 to Sinarski et al. and assigned to the assignee of the present invention. However, the need to have a large surface within the plenum for the damper to seal against limits the design of such vents and such a system cannot be employed in many designs.

It is desired to have a damper system for automotive ventilation systems which can provide an effective seal for the lifetime of the vehicle while allowing a wide range of designs of the plenum and vent.

### SUMMARY OF THE INVENTION

It is an object of the present invention to provide a novel damper system for an automotive air vent which obviates or mitigates at least one disadvantage of the prior art.

According to a first aspect of the present invention, there is provided a damper system for a ventilation system, comprising: a plenum having an upstream end and a downstream end and including first and second sealing members extending into the plenum, each of the first and second sealing members extending about a portion of the perimeter of the interior of the plenum, each of the first and second sealing members including one of a groove and an upraised rib; a damper door mounted within the plenum and rotatable therein between a closed position wherein the damper door abuts the first and second sealing surface inhibiting airflow through the plenum and an open position permitting airflow through the plenum, the damper door including the other of an upraised rib and groove on its faces to engage the one of a groove and upraised rib on each of the sealing members to form a substantially airtight seal between the damper door and the sealing members when the damper door is in the closed position.

Preferably, the damper door includes an upraised rib about a portion of each face of the damper door and each of the first and second sealing members includes a complementary groove to receive the upraised rib when the damper door is in the closed position.

The present invention provides novel damper system for controlling airflow through a plenum. The damper system provides an effective seal between a rotatable damper door and the plenum to substantially inhibit airflow through the plenum without requiring additional sealing materials such as rubber or foam. When the damper door is in the closed position, an upstanding rib on each of the upper and lower portions of the damper door engage a complementary groove in a respective sealing member on the interior of the plenum against which the damper door faces abut. The engagement of the ribs in the groove provides a seal comprising three surface-to-surface interfaces. The sealing members are relatively small, compared to the size of the plenum, and thus present little impediment to airflow through the plenum when the damper door is rotated to an open position.

### BRIEF DESCRIPTION OF THE DRAWINGS

Preferred embodiments of the present invention will now be described, by way of example only, with reference to the attached Figures, wherein:

FIG. 1 shows an exploded perspective view from the front and side of a damper system in accordance with the present invention;

FIG. 2 shows a section through a portion of the damper system of FIG. 1 when assembled, taken along line 2-2 of FIG. 1;

FIG. 3 shows a section through the damper and plenum of the damper system of FIG. 1 showing details of the seal between the damper and the plenum;

FIG. 4 is a section through a portion of the damper system of FIG. 1 showing a trunnion and the seal between the damper and the plenum; and

FIG. 5 is a section through a portion of the damper system of FIG. 1 showing a receptacle and the seal between the damper and the plenum.

### DETAILED DESCRIPTION OF THE INVENTION

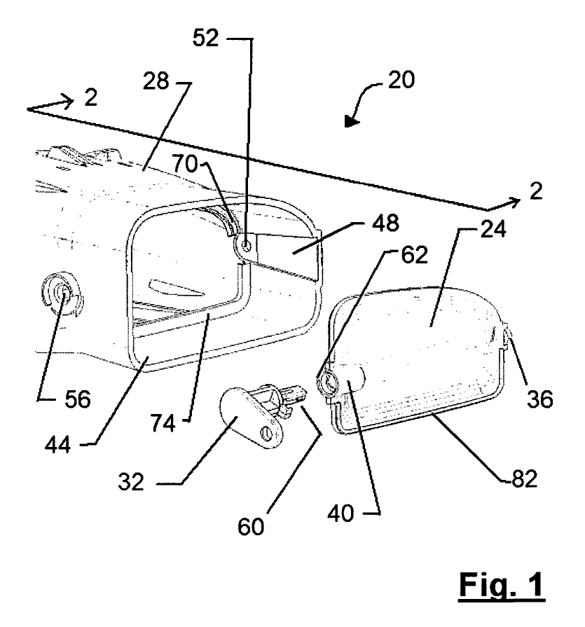

A damper system in accordance with an embodiment of the present invention is indicated generally at 20 in FIG. 1 and is discussed below with reference to FIGS. 1 through 5. Damper system 20 includes a damper door 24, a vent plenum 28 and a control arm 32. In the orientation shown in FIG. 1, plenum 28 is supplied with air from the right-hand side of FIG. 1 (the upstream side) and the air passes through plenum 28 when damper door 24 is open (as discussed below) to the left-hand side of the Figure (the downstream side) where the airflow can be directed by louvers and/or vents, not shown.

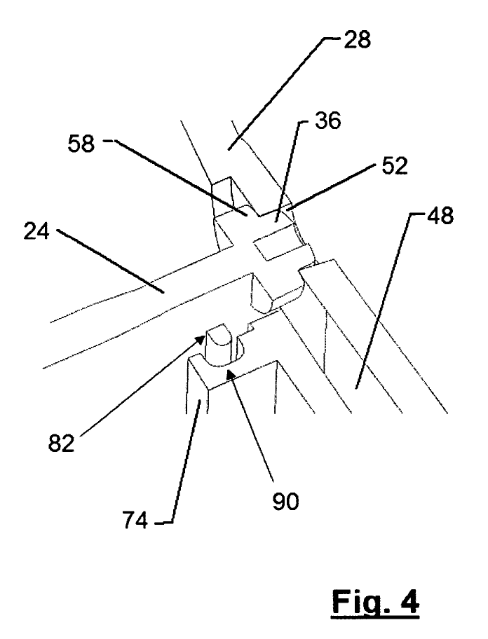

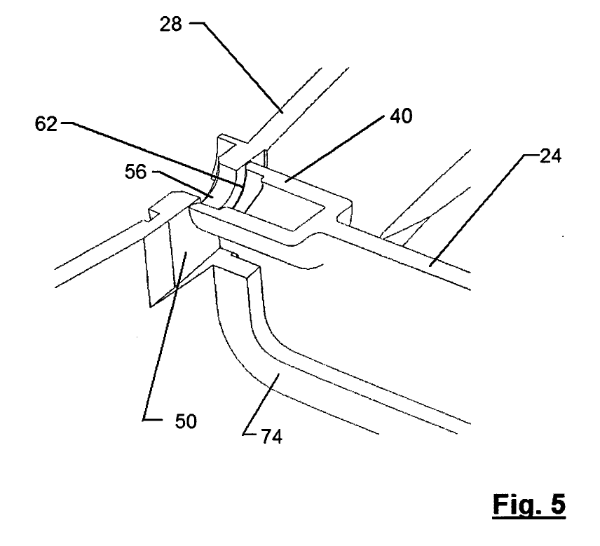

Damper door 24 can be fabricated in any suitable manner such as by injection molding and as will be apparent, damper door 24 is sized and shaped to fit within vent plenum 28 and to be rotated therewithin. Specifically, damper door 24 includes a cylindrical trunnion 36 (best seen in FIG. 4) on one edge and a cylindrical receptacle 40 (best seen in FIGS. 1 and 5) on an opposite edge. As described below, trunnion 36 and receptacle 40 form an axis about which damper door 24 can be rotated within plenum 28.

To assemble damper door 24 into plenum 28, damper door 24 is slid into the upstream opening 44 of plenum 28 such that trunnion 36 enters a groove 48 in the wall of opening 44 and receptacle 40 enters a similar groove 50 (shown in FIG. 5) on the opposite wall of opening 44. Damper door 24 is pressed into opening 44 of plenum 28 until trunnion 36 snaps into cylindrical bore 52, which is at the end of groove 48 and which extends through the wall of plenum 28, and receptacle 40 engages groove 50 and is pressed along groove 50 until receptacle 40 is aligned with bore 56 which extends through the opposite wall of plenum 28.

As illustrated in FIG. 4, trunnion 36 includes a cylindrical shoulder portion 58 which abuts the inside of groove 48 to substantially seal bore 52 such that air within vent plenum 28 does not exit through bore 52.

As best seen in FIG. 1, control arm 32 includes a male snap arm portion 60 which is next inserted into receptacle 40 through bore 56 and is retained therein by the biasing of the snap portion 60 into receptacle 40. As best seen in FIG. 5, in a manner similar to shoulder portion 58, receptacle 40 includes a cylindrical face 62 which abuts groove 50 into which receptacle 40 is placed during assembly to substantially seal bore 56 when damper door 24 is assembled within vent plenum 28 such that air within vent plenum 28 does not exit through bore 56.

When assembled, damper door 24 is thus retained within plenum 28 and rotation of control arm 32 will result in rotation of damper door 24 about the axis extending between trunnion 36 and receptacle 40.

Vent plenum 28 is equipped with an upper sealing member 70, in the form of a ledge extending inwardly from plenum 28, and a lower sealing member 74, also in the form of a ledge extending inwardly from plenum 28. Upper sealing member 70 encloses the upper half of plenum 28 downstream of bores 52 and 56, while lower sealing member 74 encloses the lower half of plenum 28 upstream of bores 52 and 56.

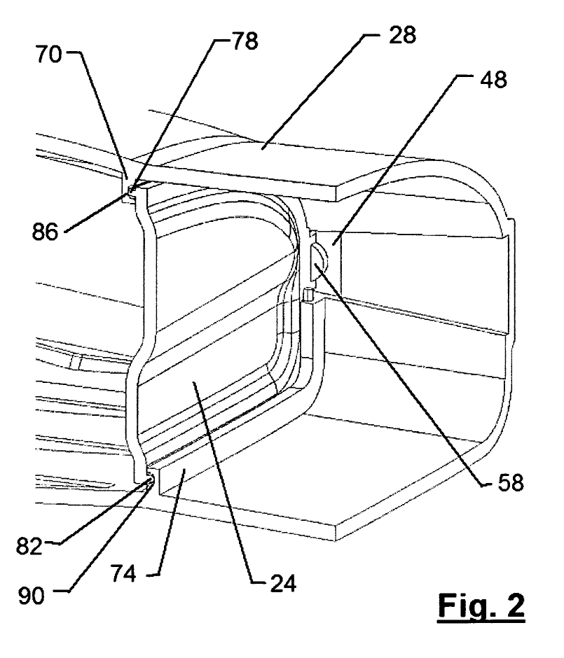

As best seen in FIG. 2, when damper door 24 is in the closed position extending across plenum 28, the upper downstream edge of damper door 24 abuts upper sealing member 70 and the lower upstream edge of damper door 24 abuts lower sealing member 74. To open damper system 20, damper door 24 is rotated clockwise (when viewed from the orientation of FIG. 2) moving the upper and lower edges of damper door 24 away from the upper sealing member 70 and lower sealing member 74 respectively.

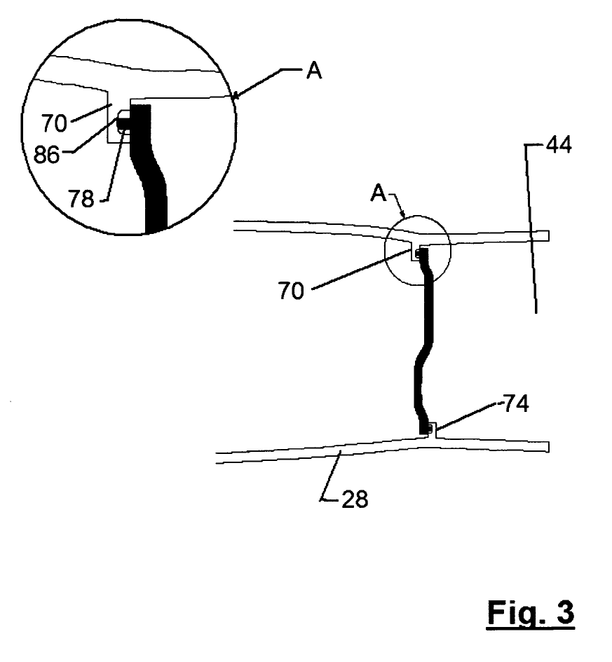

As can be seen in FIGS. 2 and 3, upper sealing member 70 and lower sealing member 74 extend only a relatively small distance from plenum 28 to improve airflow through plenum 28 when damper door 24 is in an open position. Accordingly, to provide an effective seal when damper door 24 is in a closed position, damper door 24 includes an upraised rib 78 about the upper half of its downstream face and a similar upraised rib 82 about the lower half of its upstream face.

When damper door 24 is in the closed position, rib 78 engages a complementary shaped groove 86 in upper sealing member 70 and rib 82 engages a complementary shaped groove 90 in lower sealing member 74. As can best be seen in FIGS. 3 and 4, when damper door 24 is in the illustrated closed position, ribs 78 and 82 are engaged with grooves 86 and 90, respectively, to form a substantially air tight seal between plenum 28 and damper door 24.

As should now be apparent to those of skill in the art, an effective air seal is thus provided between damper door 24 and plenum 28 in damper system 20 without the necessity of providing rubber or foam sealing elements. In the closed position, the surface of damper door 24 abuts the surface of sealing member 70 on each side of groove 86 and rib 82 abuts the bottom of groove 86, thus providing three surface-to-surface interfaces. Similarly, the surface of damper door 24 abuts the surface of sealing member 74 on each side of groove 90 and rib 82 abuts the bottom of groove 90, thus providing three surface-to-surface interfaces. By providing three surface-to-surface interfaces, an effective seal is obtained without the necessity of additional sealing materials. Further, relatively substantial manufacturing tolerances in the size of the door can be accommodated without affecting the seal provided by the three surface-to surface interfaces as ribs 78 and 82 would merely be moved up or down within grooves 86 and 90 respectively.

As will now be apparent, the present invention can also be achieved with the locations of ribs 78 and 82 and grooves 86 and 90 interchanged. Specifically, grooves 86 and 90 can be formed in damper door 24 and ribs 78 and 82 can be formed on sealing members 70 and 74. Other alternatives will occur to those of skill in the art, such as one of ribs 78 and 82 being formed on damper door 24 with its respective complementary groove 86 and 90 being formed on the respective sealing member 70 and 74, and the other of ribs 78 and 82 being formed on the other of sealing members 70 and 74 and the respective complementary groove 86 and 90 being formed on damper door 24. Further, the contact between the upper and/or lower surfaces of damper door 24 and the respective sealing members can include two ribs and complementary grooves, if desired.

The present invention provides a damper system which accomplished an effective seal between damper door 24 and plenum 28 to substantially inhibit airflow through plenum 28, without requiring additional sealing materials such as rubber or foam, when damper door 24 is in the closed position. When damper door 24 is in an open position, sealing members 70 and 74 present little impediment to airflow through plenum 28 and do not introduce any substantial noise to such an airflow.

The above-described embodiments of the invention are intended to be examples of the present invention and alterations and modifications may be effected thereto, by those of skill in the art, without departing from the scope of the invention which is defined solely by the claims appended hereto.

We claim:

1. A damper system for a ventilation system, comprising:
a plenum having an upstream end and a downstream end and including first and second sealing members extending into the plenum, each of the first and second sealing members extending about a portion of the perimeter of the interior of the plenum, each of the first and second sealing members including one of a groove and an upraised rib;
a damper door mounted within the plenum and rotatable therein between a closed position wherein the damper door abuts the first and second sealing surface inhibiting airflow through the plenum and an open position permitting airflow through the plenum, the damper door including the other of an upraised rib and groove on its faces to engage the one of a groove and upraised rib on each of the sealing members to form a substantially airtight seal between the damper door and the sealing members when the damper door is in the closed position.

2. The damper system of claim 1 wherein the damper door includes an upraised rib about a portion of each face of the damper door and each of the first and second sealing members includes a complementary groove to receive the upraised rib when the damper door is in the closed position.

3. The damper system of claim 2 wherein, in the closed position, each side of each respective groove abuts a respective face of the damper door and the upraised rib abuts the bottom of the groove, forming three surface-to-surface interfaces between the damper door and the sealing members.

4. The damper system of claim 1 wherein the plenum and the damper door are formed by injection molding.

5. The damper system of claim 1 wherein the first and second sealing members do not substantially inhibit airflow through the plenum when the damper is in the open position.

6. The damper system of claim 1 wherein the damper door can be placed in positions intermediate the closed position and the open position to modulate the flow of air through the plenum.
